(19) United States
(12) Patent Application Publication
(10) Pub. No.: US 2023/0394570 A1
(43) Pub. Date: Dec. 7, 2023

(54) ELECTRONIC MORTGAGE BROKERING AND MONITORING

(71) Applicant: Moneycatcha Pty Ltd, Perth (AU)

(72) Inventors: Ruth Hatherley, Victoria Park (AU); Jonathan Edward Macdonald, Stratford-Upon-Avon (GB)

(21) Appl. No.: 18/237,324

(22) Filed: Aug. 23, 2023

Related U.S. Application Data
(63) Continuation of application No. 18/081,500, filed on Dec. 14, 2022.
Application No. 18/081,500 is a continuation of application No. 17/195,630, filed on Mar. 8, 2021, now abandoned.
Application No. 17/195,630 is a continuation of application No. 16/303,135, filed on Nov. 19, 2018, now abandoned.

(30) Foreign Application Priority Data
Jun. 1, 2016 (AU) 2016902100
Nov. 21, 2016 (AU) 2016904745

(51) Int. Cl. G06Q 40/03; G06F 16/23; G06Q 10/10; G06Q 30/018; G06Q 30/02; G06Q 50/16; G06Q 50/26

(52) U.S. Cl. CPC G06Q 40/03; G06F 16/2365; G06Q 10/10; G06Q 30/0185; G06Q 30/0278; G06Q 50/16; G06Q 50/265

(57) ABSTRACT

Provided is a financial transaction arrangement 1 which generally comprises a distributed processing arrangement and includes an identification service computing system 2, a financial institution computing system 3, a property registry computing system 4, a lender computing system 5, an appraiser 6, and a mortgage brokering computing system 8. All of these computing systems 2, 3, 4, 5 and 8 are interconnected by means of communications network 200 which incorporates a blockchain. Via a number of transactions, the mortgage brokering computing system 8 generates aggregate blockchains on the network 200 able to provide a demonstrable and auditable history for captured identification details and subsequent transactions required for automatically brokering a mortgage.

### CROSS-REFERENCE TO RELATED APPLICATIONS

This application is a continuation of U.S. patent application Ser. No. 18/081,500 filed on Dec. 14, 2022, which is a continuation of Ser. No. 17/195,630 filed on Mar. 8, 2021, which is a continuation of U.S. patent application Ser. No. 16/303,135, filed on Nov. 19, 2018, which is a National Stage Entry of PCT/AU2017/050456 filed on May 17, 2017. This application claims priority to, and incorporates by reference the entire disclosures of, Australian Patent Application No. 2016904745, filed on Nov. 21, 2016 and Australian Patent Application No. 2016902100, filed on Jun. 1, 2016.

### TECHNICAL FIELD

This invention relates to the field of financial technology, particularly electronic and/or online mortgage brokering, in general, and more specifically to a financial transaction arrangement, a mortgage brokering computing system, and a computer-implemented mortgage brokering method.

### COPYRIGHT NOTICE/PERMISSION

A portion of the disclosure of this patent specification contains material that is subject to copyright protection. The copyright owner has no objection to the facsimile reproduction by anyone of the patent specification or parts thereof as it appears in the file or records of a Patent Office, but otherwise reserves all copyrights whatsoever.

### BACKGROUND ART

The following discussion of the background art is intended to facilitate an understanding of the present invention only. The discussion is not an acknowledgement or admission that any of the material referred to is or was part of the common general knowledge as at the priority date of the application.

Few individuals have enough savings or liquid funds to enable them to purchase property outright and it is normal practice for property or home purchases to be funded by a mortgage loan.

Traditionally, banks and other lending institutions have sold their own mortgage products. However, as markets for mortgages have become more competitive, the role of the mortgage broker has become more popular. A mortgage broker typically acts as an intermediary who brokers mortgage loans on behalf of individuals or businesses.

In most developed mortgage markets, mortgage brokers are the largest sellers of mortgage products for lenders. Mortgage brokers exist to find a bank or a direct lender that an individual seeks with a specific loan the individual is seeking.

The majority of mortgage brokers are regulated to ensure compliance with banking and/or finance laws in the jurisdiction of a consumer. As a result, it is not uncommon for a large number of parties to be involved in a typical mortgage brokering transaction, with each party having their own internal processes, documentation and security requirements.

As a result, the period of time required to perform all the required creditworthiness checks, property verifications, collateral reviews, etc. can take weeks to months. Given the number of parties and the numerous independent steps generally involved in conventional mortgage brokering, one major shortcoming is an inability to verify relevant information inherent to the transaction to an acceptable level. Given that the mortgage brokering field is typically heavily regulated, this inability to verify information often leads to potential liability issues for the parties involved.

Accordingly, there exists a need in the art for a mortgage brokering approach able to provide a verifiable audit trail to alleviate the potential liability for some or all of the parties involved.

In addition, in the conventional mortgage brokering field, risk reviews of existing home loans are either reactive, meaning a financial institution or lender is only alerted of a change in the risk profile of a loan if the client misses a repayment or defaults on their loan, or occur via a manual process with limited or outdated information.

As such, Applicant is unaware of any formal, regular ongoing review of loans inside an active mortgage portfolio, such as a residential home loan portfolio, for lenders or similar financial institutions. This means, aside from measuring delinquency rates (typically a percentage of loans in arrears in a loan portfolio), there is a severe lack of understanding of the actual risk exposure of a loan book and no intuitive way to predict changes or movements in the risk of any one loan file.

There is thus a further need in the art for means whereby a mortgage or loan can be easily and dynamically reviewed for any changes in a borrower's financial and personal circumstances that reflect a change in their risk profile. This would enable a lender or financial institution to proactively and intuitively manage their loan book and to take action immediately upon being alerted of a borrower being at risk of default or falling outside their credit comfort thresholds.

In light of the known prior art, the Inventor has identified a need for more elegant, secure and transparent mortgage brokering. As such, the present invention seeks to propose possible solutions, at least in part, in amelioration of some of the known shortcomings in the art.

### SUMMARY OF THE INVENTION

As will be understood by the skilled addressee, a blockchain is a distributed electronic ledger or publicly-accessible database that maintains a continuously-growing list of electronic data records hardened against tampering and revision. A blockchain typically consists of data structure blocks with each block holding batches of individual transactions. Each block contains a timestamp and information linking it to a previous block, typically via a hash of the prior block. The linked blocks form a chain, with each additional block reinforcing those before it. A blockchain is peer-to-peer over an open communications network, such as the Internet, where every user is allowed to connect to the blockchain ledger, send new transactions to it, verify transactions, and create new blocks.

It is to be appreciated that reference herein to a ‘borrower’ and a ‘lender’ may also refer to a potential borrower and lender, including an applicant for a loan as the borrower and any financial institution desirous of lending funds to such a potential borrower as the lender, or the like.

It is further to be appreciated that reference to a ‘transaction’ herein generally refers to an electronic provision, transfer or exchange of digital information across an open and/or secured communications network, such as the Internet, an intranet, and/or the like. Accordingly, where it is evident to the skilled addressee that any type of information or data is provided to, or received from, a party, such action is likely to constitute a transaction.

According to one aspect of the invention there is provided a financial transaction arrangement comprising:
an identification service computing system having a database of identification records of potential borrowers;
a financial institution computing system having a database with record of a borrower's ability to repay a mortgage or loan;
a property registry computing system having a database of records of potential mortgageable assets;
a lender computing system having a database of records of borrowers with mortgages with an associated lender; and
a mortgage brokering computing system, wherein the computing systems are operatively interconnected in signal communication via a communications network incorporating a blockchain, the mortgage monitoring computing system configured to:
   i) provide an interface to capture borrower identification details, asset identification details, and a lender discrimination model;
   ii) transact with the identification service computing system to verify the authenticity of the captured borrower identification details;
   iii) transact with the financial institution computing system to establish a creditworthiness rating for the borrower;
   iv) transact with the property registry computing system to verify the authenticity of the captured asset details;
   v) transact with a suitable appraiser to assign a value to the verified asset;
   vi) record the capturing, verification, creditworthiness and valuation transactions in a blockchain;
   vii) automatically compare the borrower identification details, creditworthiness rating, asset identification details and asset valuation with the lender discrimination model to produce a lending decision; and
   viii) record the comparison transaction and lending decision in a blockchain;
      wherein an artificial and technical effect resides in the mortgage brokering computing system generating aggregate blockchains on the network providing a demonstrable and auditable history for the respective captured identification details and subsequent transactions for brokering a mortgage.

Typically, the mortgage brokering computing system is further configured to:
i) transact with the financial institution computing system to review the creditworthiness rating of the borrower;
ii) record the creditworthiness review transaction in a blockchain;
iii) compare the creditworthiness review with the lender's discrimination model based on lending requirements; and
iv) if the borrower's creditworthiness rating compares unfavourably with the lender's discrimination model, automatically notify the lender computing system;
   wherein an artificial and technical effect resides in the creation of an auditable history of the creditworthiness review transaction as well as facilitating automatic and periodic monitoring of the lender's borrowers to notify said lender should a borrower's creditworthiness rating change with respect to such lender's discrimination model.

Typically, the borrower identification details are selected from a non-exhaustive group consisting of a name, a license number, a passport number, an identity number, and biometric information.

Typically, the identification service computing system is selected from a non-exhaustive group consisting of a vehicle licensing authority, a passport control authority, a financial institution, a tax authority, and a government records authority.

Typically, the borrower identification details include consent from such borrower in compliance with privacy and/or security requirements.

Typically, the property registry computing system includes records selected from a non-exhaustive group consisting of an immovable property street address, a lot or plan number, a standard parcel identifier, and a movable property identification or registration number.

In one example, the mortgage brokering computing system recording a transaction in a blockchain comprises said system being configured to use an alternative chain based on the block chain algorithm to achieve distributed consensus of said transactions.

Typically, the lender discrimination model comprises a plurality of lending requirements against which a borrower's suitability for a mortgage is assessed.

In one example, the mortgage brokering computing system is configured to compile the lender discrimination model from captured lending requirements to produce at least two categories of lending decisions.

In one example, the mortgage brokering computing system automatically comparing the borrower identification details, creditworthiness rating, asset identification details and asset valuation with the discrimination model to produce a lending decision comprises said system categorising these details into the at least two categories of lending decisions.

Typically, each category of lending decisions indicates a particular mortgage product of the lender.

In one example, the mortgage brokering computing system is adapted to automatically generate and/or populate supporting documentation with transaction data.

Typically, the mortgage brokering computing system is adapted to provide such populated supporting documentation to a party for electronic signature, and to record such transaction in a blockchain.

Typically, where the lending decision is in the affirmative, the mortgage brokering computing system is further configured to facilitate a transfer of funds from the lender to secure the asset for the borrower.

According to a further aspect of the invention there is provided a mortgage brokering computing system comprising:
(1) an input interface configured to receive transaction data from a communications network;
(2) an output interface configured to transmit transaction data onto a communications network;
(3) a non-transitory electronic storage device configured to house a database for storing processor instructions; and
(4) a processor operatively arranged in signal communication with the input and output interfaces and the storage device, said processor adapted to:
for a borrower:
   i) capture borrower identification details;
   ii) verify such captured identification details with a third-party identification service;
   iii) establish a creditworthiness rating with a third-party financial institution; and
   iv) record the capturing, verification and creditworthiness transactions in a blockchain;
for an asset to be mortgaged:
   i) capture asset identification details;
   ii) verify such captured asset details with a third-party property registry;
   iii) value the verified asset; and
   iv) record the capturing, verification and valuation transactions in a blockchain;
for a lender:
   i) configure a discrimination model based on lending requirements;
   ii) automatically compare the borrower identification details, creditworthiness rating, asset identification details and asset valuation with the discrimination model to produce a lending decision; and
   iii) record the comparison transaction and lending decision in a blockchain;
      wherein an artificial and technical effect resides in the system generating aggregate blockchains providing a demonstrable and auditable history for the respective identification details and subsequent transactions for brokering a mortgage.

In one example, the processor of the mortgage brokering computing system is further configured to:
i) transact with a financial institution via the communications network to review a creditworthiness rating of a borrower having a mortgage with a lender;
ii) record the creditworthiness review transaction in a blockchain via the communications network;
iii) compare the creditworthiness review with a lender's discrimination model based on lending requirements; and
iv) if the borrower's creditworthiness rating compares unfavourably with the lender's discrimination model, automatically notify the lender;
   wherein an artificial and technical effect resides in the creation of an auditable history of the creditworthiness review transaction as well as facilitating automatic and periodic monitoring of the lender's borrowers to notify said lender should a borrower's creditworthiness rating change with respect to such lender's discrimination model.

According to a further aspect of the invention there is provided a computer-implemented mortgage brokering method comprising the steps of:
for a borrower:
   i) capturing borrower identification details;
   ii) verifying such captured identification details with a third-party identification service;
   iii) establishing a creditworthiness rating with a third-party financial institution; and
   iv) recording the capturing, verification and creditworthiness transactions in a blockchain;
for an asset to be mortgaged:
   i) capturing asset identification details;
   ii) verifying such captured asset details with a third-party property registry;
   iii) valuing the verified asset; and
   iv) recording the capturing, verification and valuation transactions in a blockchain;
for a lender:
   i) configuring a discrimination model based on lending requirements;
   ii) automatically comparing the borrower identification details, creditworthiness rating, asset identification details and asset valuation with the discrimination model to produce a lending decision; and
   iii) recording the comparison transaction and lending decision in a blockchain;
      wherein an artificial and technical effect resides in the aggregate blockchains providing a demonstrable and auditable history for the respective identification details and subsequent transactions for brokering a mortgage.

In one example, the method comprises the further steps of:
i) transacting with the financial institution to review a creditworthiness rating of a borrower having a mortgage with a lender;
ii) recording the creditworthiness review transaction in a blockchain;
iii) comparing the creditworthiness review with a lender's discrimination model based on lending requirements; and
iv) if the borrower's creditworthiness rating compares unfavourably with the lender's discrimination model, automatically notifying the lender;
   wherein an artificial and technical effect resides in the creation of an auditable history of the creditworthiness review transaction as well as facilitating automatic and periodic monitoring of the lender's borrowers to notify said lender should a borrower's creditworthiness rating change with respect to such lender's discrimination model.

Typically, the step of capturing the borrower identification details may comprise providing an online electronic portal via which identification details are receivable.

In one example, the borrower identification details may be selected from a non-exhaustive group consisting of a name, a license number, a passport number, an identity number, and biometric information. The borrower identification details may also include consent from such borrower in compliance with privacy and/or security requirements.

In one example, the step of verifying such captured identification details with a third-party identification service may include securely transacting with said service to verify the authenticity of the identification details.

Typically, the third-party identification service may be selected from a non-exhaustive group consisting of a vehicle licensing authority, a passport control authority, a financial institution, a tax authority, and a government records authority.

Typically, the step of establishing a creditworthiness rating with a third-party financial institution may include transacting with said financial institution to determine the borrower's ability to repay a mortgage.

In one example, the step of recording the capturing, verification and creditworthiness transactions in a blockchain may include using an alternative chain based on the block chain algorithm to achieve distributed consensus of said transactions.

In one example, the step of capturing the asset identification details may comprise providing an online electronic portal via which asset identification details are receivable.

In one example, the asset identification details may be selected from a non-exhaustive group consisting of an immovable property street address, lot or plan number, or a standard parcel identifier; and movable property identification or registration number.

Typically, the step of verifying such captured asset identification details with a third-party property registry may include securely transacting with said registry to verify the authenticity of the asset identification details.

Typically, the step of valuing the verified asset may comprise transacting with a suitable appraiser to assign a value to the asset.

Typically, the step of recording the capturing, verification and valuation transactions in a blockchain may include using an alternative chain based on the block chain algorithm to achieve distributed consensus of said transactions.

In one example, the step of configuring a discrimination model based on lending requirements may comprise compiling the lending requirements to produce at least two categories of lending decisions.

In one example, the step of automatically comparing the borrower identification details, creditworthiness rating, asset identification details and asset valuation with the discrimination model to produce a lending decision may comprise categorising such details into the at least two categories.

Typically, each category may indicate a particular mortgage product of the lender.

Typically, the step of recording the comparison transaction and lending decision in a blockchain may include using an alternative chain based on the block chain algorithm to achieve distributed consensus of said transactions.

In one example, the method may include the further step of automatically generating and/or populating supporting documentation with transaction data.

Typically, the method may further include the step of electronically providing such populated supporting documentation to a party for electronic signature, and recording such transaction in a blockchain.

Typically, a step of recording a transaction in a blockchain may include storing supporting documentation for such transaction and associated with said blockchain in a non-transitory electronic storage means.

Typically, the supporting documentation may be encrypted for storage.

Typically, where the lending decision is in the affirmative, the method may include the further step of facilitating a transfer of funds from the lender to secure the asset for the borrower.

According to a further aspect of the invention there is provided a computer programme product which, when executed by a suitable processing system, facilitates the performance of the method according to an aspect of the invention above.

### BRIEF DESCRIPTION OF THE DRAWINGS

FIG. 1 is a diagrammatic overview representation of a financial transaction arrangement in accordance with one aspect of the invention;

FIG. 2 illustrates a functional block diagram of an example computing or processing system that can be utilised to embody or give effect to a particular embodiment of any computing system, such as the mortgage brokering system;

FIG. 3 illustrates an example network infrastructure that can be utilised to embody or give effect to a particular embodiment of a communications network whereby transactions can be performed between computing systems;

FIG. 4 is a diagrammatic overview representation of a mortgage brokering method in accordance with an aspect of the invention;

FIG. 5 is a diagrammatic representation of method steps for capturing and verifying borrower identification details, as well as subsequent blockchaining of these transactions;

FIG. 6 is a diagrammatic representation of method steps for capturing and verifying asset identification details and valuating such asset, as well as subsequent blockchaining of these transactions;

FIG. 7 is a diagrammatic representation of method steps for establishing a creditworthiness rating for a borrower, as well as subsequent blockchaining of these transactions;

FIG. 8 is a diagrammatic representation of method steps for configuring a discrimination model based on lending requirements and comparing the borrower identification details, creditworthiness rating, asset identification details and asset valuation with the discrimination model to produce a lending decision, as well as subsequent blockchaining of these transactions;

FIG. 9 is a diagrammatic representation of method steps for generating and providing supporting documentation, as well as subsequent blockchaining of these transactions;

FIG. 10 is a diagrammatic representation of method steps for facilitating a transfer of funds from the lender to secure the asset for the borrower, as well as subsequent blockchaining of these transactions;

FIG. 11 is a diagrammatic representation of one example of method steps for a mortgage monitoring method.

### DETAILED DESCRIPTION OF EMBODIMENTS

The following modes, given by way of example only, are described in order to provide a more precise understanding of the subject matter of a preferred embodiment or embodiments of the present disclosure. In the figures, incorporated to illustrate features of an example embodiment or embodiments, like reference numerals are used to identify like parts throughout.

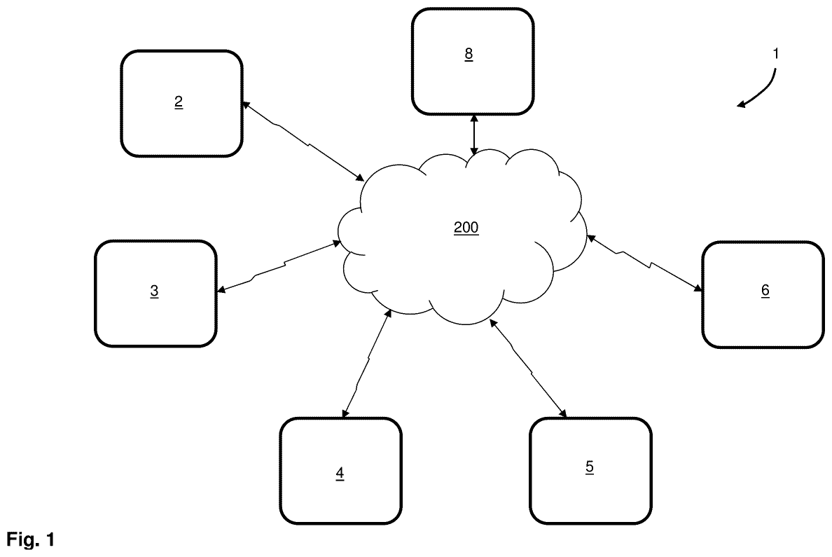

Referring firstly to FIG. 1 of the accompanying drawings, there is shown one embodiment of a financial transaction arrangement 1. The financial arrangement 1 generally comprises a distributed processing arrangement and includes an identification service computing system 2, a financial institution computing system 3, a property registry computing system 4, a lender computing system 5, an appraiser 6, and a mortgage brokering computing system 8. All of these computing systems 2, 3, 4, 5 and 8 are interconnected by means of communications network 200, described in more detail below.

In general, the identification service computing system 2 includes a database of identification records of potential borrowers, the financial institution computing system 3 includes a database with record of a borrower's ability to repay a mortgage or loan, the property registry computing system 4 includes a database of records of potential mortgageable assets, and the lender computing system 5 includes a database of records of borrowers with mortgages with an associated lender.

Importantly, all the computing systems 2, 3, 4, 5 and 8 are operatively interconnected in signal communication with each other via communications network 200 that incorporates a blockchain.

In the exemplified arrangement 1, the mortgage brokering computing system 8 is configured to perform the following functions, not necessarily in the order given below:
i) provide an interface to capture borrower identification details, asset identification details, and a lender discrimination model;
ii) transact with the identification service computing system 2 to verify the authenticity of the captured borrower identification details;
iii) transact with the financial institution computing system 3 to establish a creditworthiness rating for the borrower;
iv) transact with the property registry computing system 4 to verify the authenticity of the captured asset details;
v) transact with a suitable appraiser 6 to assign a value to the verified asset;
vi) record the capturing, verification, creditworthiness and valuation transactions in a blockchain on network 200;
vii) automatically compare the borrower identification details, creditworthiness rating, asset identification details and asset valuation with the lender discrimination model to produce a lending decision; and
viii) record the comparison transaction and lending decision in a blockchain on network 200.

In this manner, an artificial and technical effect is created by the mortgage brokering computing system 8 generating such aggregate blockchains able to provide a demonstrable and auditable history for the respective captured identification details and subsequent transactions for brokering a mortgage.

Typically, the mortgage monitoring computing system 8 is further configured to:
i) transact with the financial institution computing system 3 to review the creditworthiness rating of the borrower from time-to-time;
ii) record the creditworthiness review transaction in a blockchain on network 200;
iii) compare the creditworthiness review with the lender's discrimination model based on lending requirements; and
iv) if the borrower's creditworthiness rating compares unfavourably with the lender's discrimination model, automatically notify the lender computing system 5.

Similarly, an artificial and technical effect resides in the creation of an auditable history of the creditworthiness review transaction as well as facilitating automatic and periodic monitoring of the lender's borrowers to notify said lender should a borrower's creditworthiness rating change with respect to such lender's discrimination model.

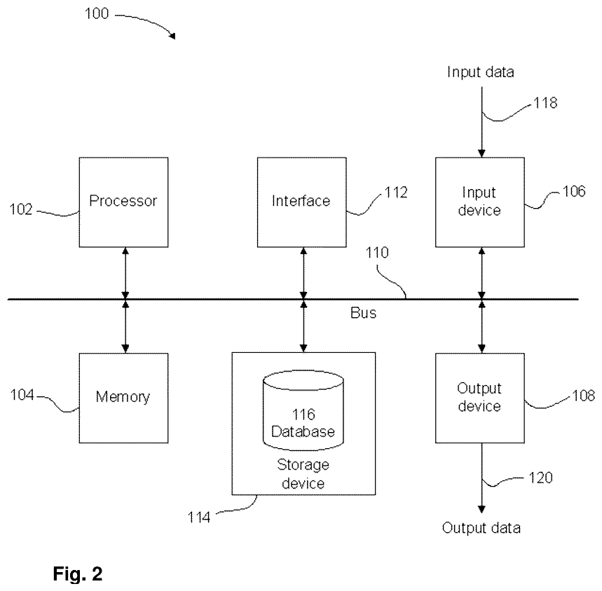

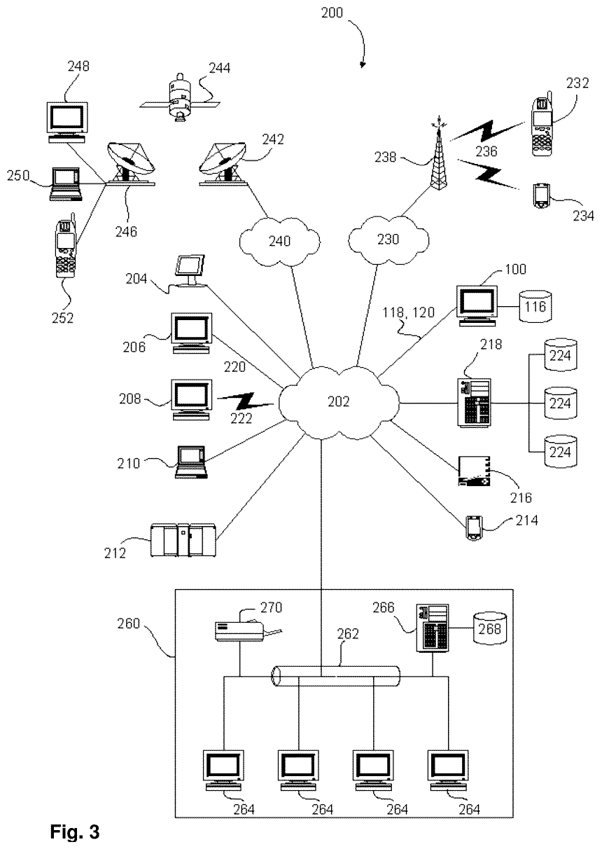

As will be readily understood by the skilled addressee, the computing systems 2, 3, 4, 5 and 8 can be realised in a variety of different manners. With reference to FIGS. 2 and 3, one broad example of such a computing or processing system 100 will be provided below, as well as a broad example of communications network 200. Afterwards, an example of a broad mortgage brokering method 10 will be described, as generally performed by the arrangement 1.

As such, it is to be appreciated that with this mortgage brokering method generally implemented via the financial transaction arrangement 1 comprising discrete computing systems, any reference herein to “means” specifically includes any one or more of a computer program product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

In general terms, in a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device.

The capability of such a terminal to request and/or receive information or data can be provided by software, hardware and/or firmware. A terminal may include or be associated with other devices, for example a local data storage device such as a hard disk drive or solid state drive.

An information source can also include a server, or any type of terminal, that may be associated with one or more storage devices that are able to store information or data, for example in one or more databases residing on a storage device. The exchange of information (i.e., the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network.

The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices.

More than one distinct network can be provided, for example a private and a public network. A network as referenced in this specification should be taken to include any type of terminal or other similar type of electronic device, or part thereof, which is rendered such that it is capable of communicating with at least one other terminal.

A particular embodiment of the computing systems 2, 3, 4, 5 or 8 of the financial transaction arrangement 1 of the present invention can be realised using a processing system 100, an example of which is shown in FIG. 2. In particular, the processing system 100 generally includes at least one processor 102, or processing unit or plurality of processors, memory 104, at least one input device 106 and at least one output device 108, coupled together via a bus or group of buses 110.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network.

Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

In addition, the processing system 100 is generally part of a networked communications system 200, as shown in FIG. 3. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised.

The transfer of information and/or data over network 202 can be achieved using wired communications means 220 or wireless communications means 222. Server 218 can facilitate the transfer of data between network 202 and one or more databases 224. Server 218 and one or more databases 224 provide an example of the remote medication management system.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246.

Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

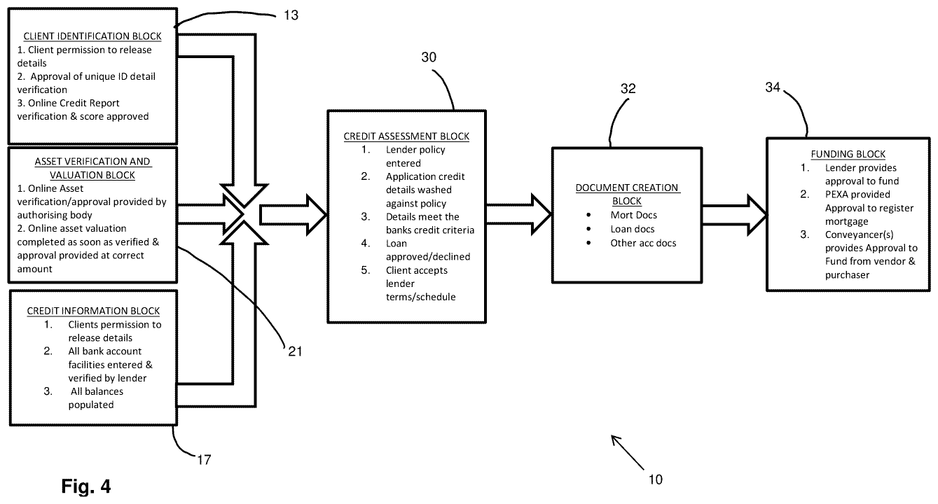

With reference now to FIG. 4 of the accompanying drawings, there is shown one broad example of a mortgage brokering method 10, in accordance with this disclosure. As described above, financial transaction arrangement 1 typically performs such a method 10. Accordingly, limitations of the method 10 are generally apposite to the arrangement 1, as will be appreciated by the skilled addressee. In addition, a party to a transaction in the below-described method 10 is generally represented by the associated computing system, e.g. the financial institution is represented by the financial institution computing system 3, the lender by the lender computing system 5, etc.

Generally, as a brokering tool, the computer-implemented method 10 broadly comprises steps (indicated by process blocks throughout) to be performed for a client or borrower (indicated at block 13 and 17), steps for an asset to be mortgaged (indicated at block 21), and steps for a lender (indicated at block 30).

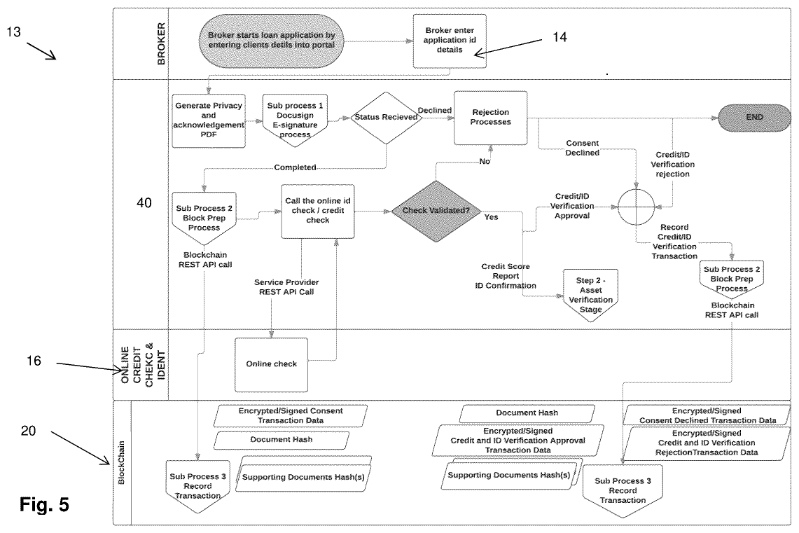

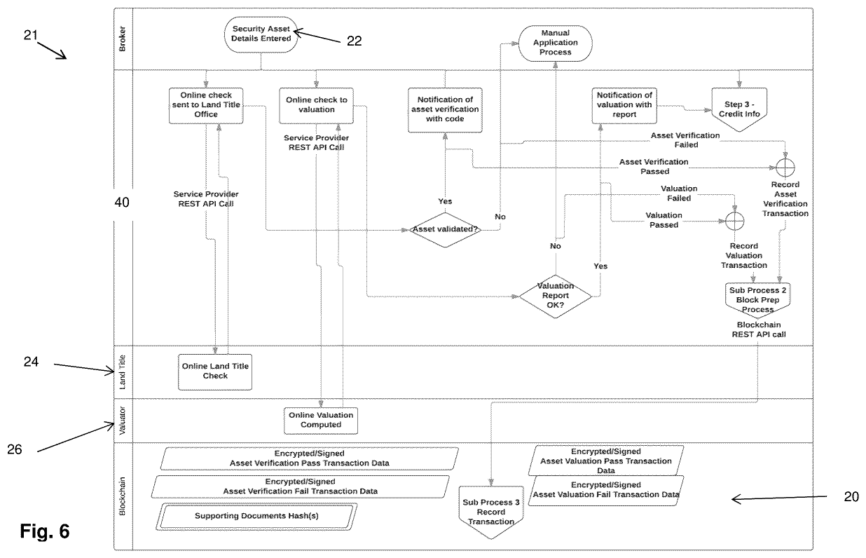

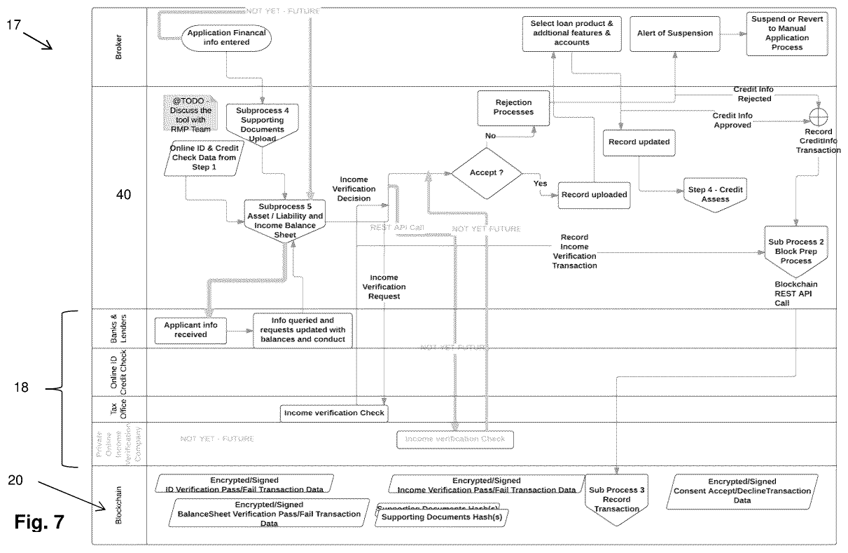

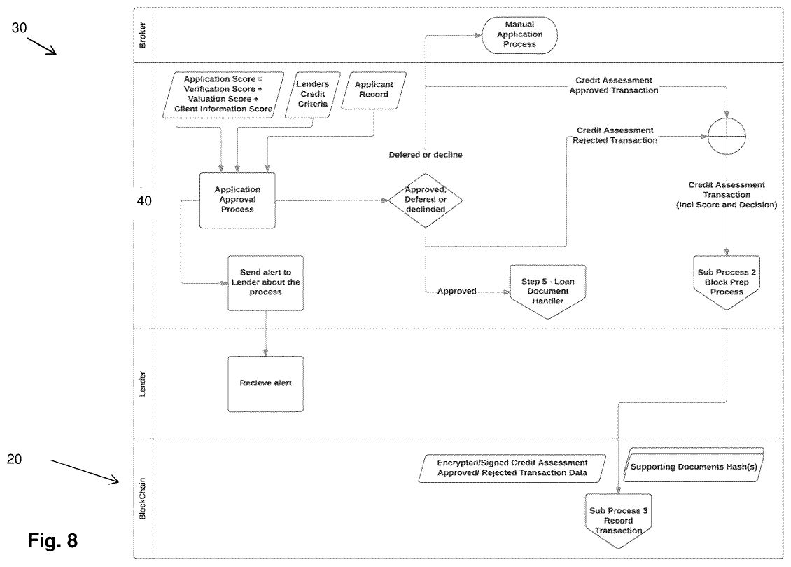

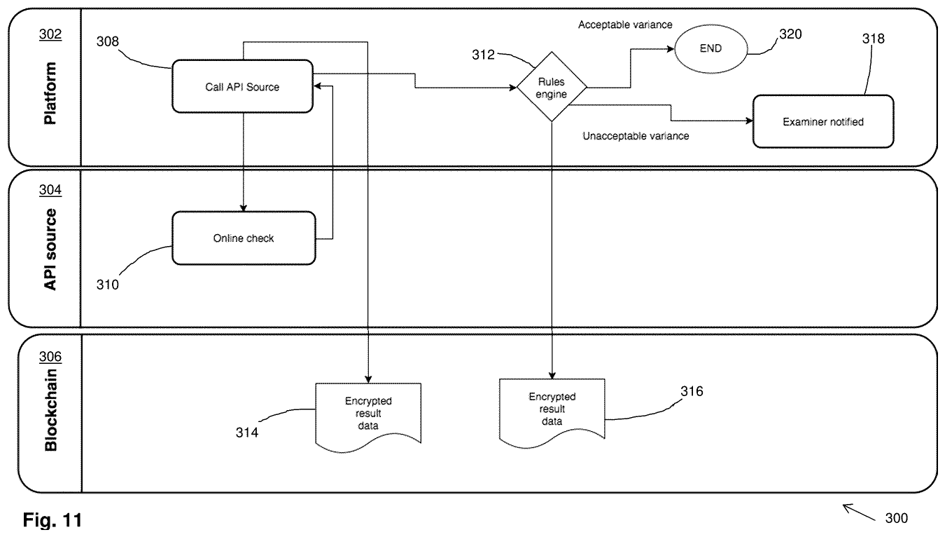

In this example, the method 10 also includes process blocks or steps for generating documentation (indicated at block 32), as well as steps to facilitate the transfer of funds from the lender in order to secure the asset for the borrower or client (indicated at block 34). FIGS. 5 to 10 each provide an example of further steps associated with each of the above steps, with FIG. 11 showing an associated review process of a creditworthiness rating of a borrower having a mortgage with a lender. It is to be appreciated that these process flow steps can be implemented in a variety of ways in other examples. In general, a role of the mortgage brokering system 8 is represented in the process flow diagrams of FIGS. 5 to 11 by means of reference numeral 40, i.e. system 40.

In general, the method 10 comprises the steps of, for a borrower, capturing borrower identification details 14, verifying such captured identification details with a third-party identification service 16, establishing a creditworthiness rating with a third-party financial institution 18, and recording the capturing, verification and creditworthiness transactions in a blockchain 20.

The method 10 also generally comprises the steps of, for an asset to be mortgaged, capturing asset identification details 22, verifying such captured asset details with a third-party property registry 24, valuing the verified asset with a suitable appraiser 26, and recording the capturing, verification and valuation transactions in a blockchain 20.

Similarly, the method 10 also generally comprises the steps of for a lender, configuring a discrimination model 28 based on lending requirements, automatically comparing the borrower identification details, creditworthiness rating, asset identification details and asset valuation with the discrimination model to produce a lending decision, and recording the comparison transaction and lending decision in a blockchain 20.

In this manner, the computer-implemented method 10 produces an artificial effect that resides in the aggregate blockchains providing a demonstrable and auditable history for the respective identification details and subsequent transactions for brokering a mortgage.

The step of capturing the borrower identification details 14 generally comprises providing an online electronic portal via which identification details are receivable, such as a website, a dedicated terminal, or the like. These borrower identification details may include a name, a license number, a passport number, an identity number, biometric information, or the like. In addition, the borrower identification details typically also include consent from the borrower in compliance with privacy and/or security requirements.

The step of verifying the captured borrower identification details 14 with a third-party identification service 16 typically includes securely transacting with the service 16 to verify the authenticity of the identification details. Similarly, this third-party identification service 16 may include a vehicle licensing authority, a passport control authority, a financial institution, a tax authority, a government records authority, or the like.

The step of establishing a creditworthiness rating with a third-party financial institution 18 typically includes transacting with this financial institution 18 to determine the borrower's ability to repay a mortgage.

The step of recording the capturing, verification and creditworthiness transactions in a blockchain can include using an alternative chain based on the block chain algorithm to achieve distributed consensus of said transactions as is well-known in the art.

The step of capturing the asset identification details 22 generally comprises providing an online electronic portal via which asset identification details are receivable. These asset identification details may include an immovable property street address, lot or plan number, or a standard parcel identifier; a movable property identification or registration number, or the like.

The step of verifying such captured asset identification details 22 with a third-party property registry 24 generally includes securely transacting with the registry 24 to verify the authenticity of the asset identification details. Similarly, the step of valuing the verified asset typically comprises transacting with a suitable appraiser 26 to assign or confirm a value of the asset.

As above, the step of recording the capturing, verification and valuation transactions in a blockchain may include using an alternative chain based on the block chain algorithm to achieve distributed consensus of said transactions.

The step of configuring a discrimination model 28 based on the lending requirements generally comprises compiling the lending requirements of each lender to produce at least two categories of lending decisions for each lender. For example, it is common practice for each lender, such as a banking institution, to define their own specific criteria of lending requirements. For a lender, the at least two categories of lending decisions may comprise a ‘suitable’ and ‘non-suitable’ category, ‘yes’ and ‘no’, or the like. Similarly, it is not uncommon for each lender to have a distinct discrimination model with a plurality of categories of lending decisions, as based on their lending requirements. Typically, each category may indicate a particular mortgage product of the lender, i.e. a particular loan product, or the like.

As before, the step of recording the comparison transaction and lending decision in a blockchain may include using an alternative chain based on the block chain algorithm to achieve distributed consensus of said transactions.

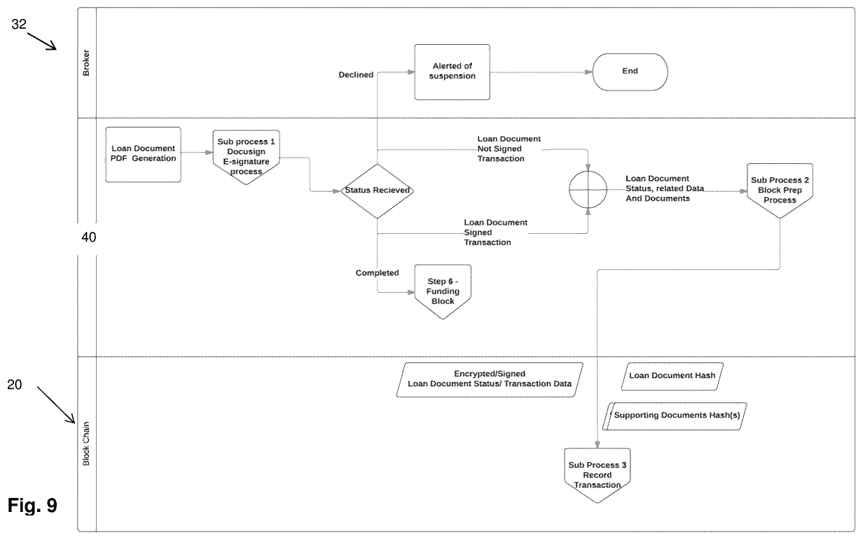

As shown in FIG. 9, this example of the method 10 also includes the further step 32 of automatically generating and/or populating supporting documentation with transaction data. The method 10 further includes the step of electronically providing such populated supporting documentation to a party for electronic signature, and recording such transaction in a blockchain 20.

In addition, the step of recording a transaction in a blockchain 20 also generally includes storing this supporting documentation for such transaction and associated with said blockchain in a non-transitory electronic storage means or device (described in more detail above). Typically, the supporting documentation is encrypted for storage.

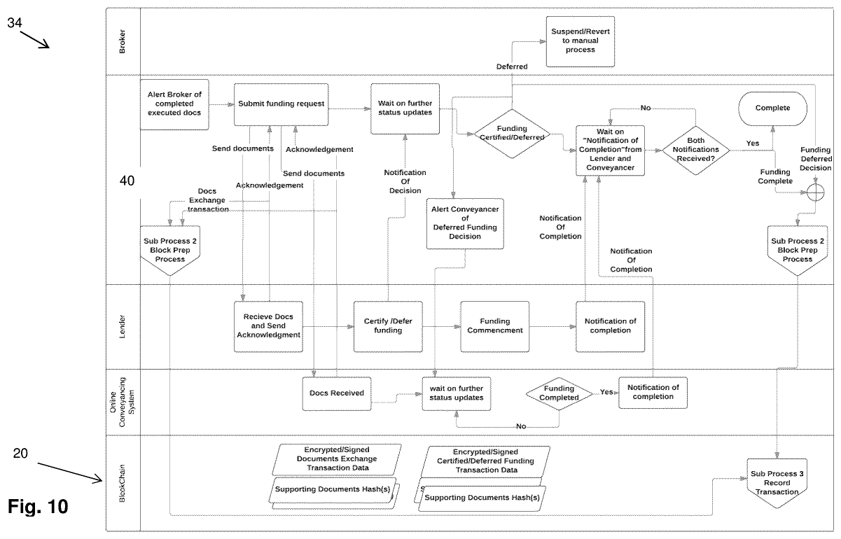

Finally, where the lending decision is in the affirmative, the method 10 includes the further step of facilitating a transfer of funds from the lender to secure the asset for the borrower, as shown in FIG. 10.

Referring to the review process example of FIG. 11, the platform 302 represents mortgage brokering computing system 8, the computing system 3 of the financial institution able to provide the borrower's creditworthiness rating, represents an API source 304, with a blockchain 306 available on the communications network 200.

In this example, the processor of the mortgage brokering computing system 8 is generally configured to transact with the financial institution 3 via the communications network 200 to review the creditworthiness rating of a borrower having a mortgage with a lender 5; to record the creditworthiness review transaction in a blockchain; to compare the creditworthiness review with a lender's discrimination model based on lending requirements; and if the borrower's creditworthiness rating compares unfavourably with the lender's discrimination model, to automatically notify the lender 5.

It is believed that an artificial and technical effect hereof resides in the creation of an auditable history of the creditworthiness review transaction as well as facilitating automatic and periodic monitoring of the lender's borrowers to notify said lender should a borrower's creditworthiness rating change with respect to such lender's discrimination model.

The step of transacting with a financial institution to review a creditworthiness rating of a borrower having a mortgage with a lender is indicated by method step 308, where such a transaction is generally an API call to the computing system of the financial institution 3.

The borrower's creditworthiness rating is done as an online check 310, which is returned to the computing system 8 or platform 302, as shown. This transaction is then recorded in a blockchain 306 as indicated by step 314. The step of comparing the creditworthiness review with a lender's discrimination model is shown by step 312 typically via some manner of rules engine. An outcome of the comparison may also be recorded in the blockchain 306 as shown at step 316.

If the borrower's creditworthiness rating compares unfavourably with the lender's discrimination model, the method includes the further step of automatically notifying the lender, as shown by step 318. Conversely, if the comparison is favourable, the method ends as per step 320.

In this manner, the method 10 and associated system are able to repeat the API calls inside the platform 302 at regular intervals. These API calls then retrieve up to date information about the borrower for each loan provided by a lender. The platform 302 then applies a set of rules to determine any variances in the information from the original loan or mortgage application and sends alerts to the lender when the movement exceeds their load or mortgage thresholds.

The information retrieved and comparison results are generally encrypted and stored in the blockchain for audit purposes as an indisputable source of truth.

Accordingly, in light of the above description, the mortgage brokering system 8 (represented by reference numeral 40 in the process flow diagrams, or as platform 302) generally comprises some manner of input interface configured to receive transaction data from a communications network, and an output interface configured to transmit transaction data onto the communications network. The system 40 also includes a non-transitory electronic storage device or means configured to house a database for storing processor instructions, as well as a processor operatively arranged in signal communication with the input and output interfaces and the storage device.

In use, the processor is adapted to, for a borrower, capture the borrower identification details, verify such captured identification details with a third-party identification service, establish a creditworthiness rating with a third-party financial institution, and record the capturing, verification and creditworthiness transactions in a blockchain.

In addition, the processor is adapted to, for an asset to be mortgaged, capture the asset identification details, verify such captured asset details with a third-party property registry, value the verified asset, and record the capturing, verification and valuation transactions in a blockchain.

The processor is further adapted to, for a lender, configure the discrimination model based on lending requirements, automatically compare the borrower identification details, creditworthiness rating, asset identification details and asset valuation with the discrimination model to produce a lending decision; and record the comparison transaction and lending decision in a blockchain.

The processor generally provides an online electronic portal via which identification details are receivable in order to capture the borrower identification details. These borrower identification details may include a name, a license number, a passport number, an identity number, and biometric information. The borrower identification details may also include consent from such borrower in compliance with privacy and/or security requirements.

The processor typically securely transacts with the third-party identification service to verify the authenticity of the identification details. This third-party identification service may include a vehicle licensing authority, a passport control authority, a financial institution, a tax authority, a government records authority, or the like.

The processor typically transacts with a third-party financial institution to determine the borrower's ability to repay a mortgage in order to establish a creditworthiness rating for the borrower.

Similarly, the processor may provide an online electronic portal via which the asset identification details are receivable in order to capture the asset identification details. These asset identification details may include an immovable property street address, lot or plan number, or a standard parcel identifier; a movable property identification or registration number, or the like. The processor generally securely transacts with the third-party property registry to verify the authenticity of the asset identification details. Accordingly, the processor typically transacts with a suitable appraiser to assign or confirm a value of the asset.

The discrimination model based on the lending requirements can be compiled by the processor to produce at least two categories of lending decisions, which could include the processor categorising such details into the at least two categories. Typically, each category may indicate a particular mortgage product of the lender.

In this example, the processor is adapted to automatically generate and populate supporting documentation with the relevant transaction data. The processor is also adapted to provide such populated supporting documentation to a party for electronic signature, and subsequently record this transaction in a blockchain. This recording typically includes the processor encrypting and storing the supporting documentation blockchain in the non-transitory electronic storage device. The processor also facilitates a transfer of funds from the lender to secure the asset for the borrower.

The Applicant believes it advantageous that the inventions described herein allow for an elegant and efficient way to broker mortgage transactions between borrowers and lenders. Advantageously, the invention provides for a computer-implemented method 10 which provides a technical effect in creating blockchains to provide an auditable history of the various transactions between the various parties involved in mortgage brokering. This is particularly advantageous given the amount of regulation inherent in most mortgage industries, thereby reducing liability of the parties involved in such transactions.

In addition, the use of the present invention enables mortgage brokering to be facilitated much quicker than conventional methods. The Applicant also believes it advantageous that the invention described herein allows for an elegant and efficient way to automatically monitor a borrower's financial position and to inform a lender should the borrower's ability to service a loan or mortgage change.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A financial transaction arrangement comprising:
an identification service computing system having a database of identification records of potential borrowers;
a financial institution computing system having a database with record of a borrower's ability to repay a mortgage or loan;
a property registry computing system having a database of records of potential mortgageable assets;
a lender computing system having a database of records of borrowers with mortgages with an associated lender; and
a mortgage brokering computing system, wherein the computing systems are operatively interconnected in signal communication via a communications network incorporating a blockchain, the mortgage brokering computing system configured to:
i) provide an interface to capture borrower identification details, asset identification details, and a lender discrimination model;
ii) transact with the identification service computing system to verify the authenticity of the captured borrower identification details;
iii) transact with the financial institution computing system to establish a creditworthiness rating for the borrower;
iv) transact with the property registry computing system to verify the authenticity of the captured asset details;
v) transact with a suitable appraiser to assign a value to the verified asset;
vi) record the capturing, verification, creditworthiness and valuation transactions in a blockchain;
vii) automatically compare the borrower identification details, creditworthiness rating, asset identification details and asset valuation with the lender discrimination model to produce a lending decision; and
viii) record the comparison transaction and lending decision in a blockchain;
wherein the mortgage brokering computing system operatively generates aggregate blockchains on the network for providing a demonstrable and auditable history for the respective captured identification details and subsequent transactions for brokering a mortgage.

2. The transaction arrangement of claim 1, wherein the mortgage brokering computing system is further configured to:
i) transact with the financial institution computing system to review the creditworthiness rating of the borrower;
ii) record the creditworthiness review transaction in a blockchain;
iii) compare the creditworthiness review with the lender's discrimination model based on lending requirements; and
iv) if the borrower's creditworthiness rating compares unfavourably with the lender's discrimination model, automatically notify the lender computing system;
wherein the mortgage brokering computing system operatively creates of an auditable history of the creditworthiness review transaction as well as facilitates automatic and periodic monitoring of the lender's borrowers to notify said lender should a borrower's creditworthiness rating change with respect to such lender's discrimination model.

3. The transaction arrangement of claim 1, wherein the borrower identification details are selected from a non-exhaustive group consisting of a name, a license number, a passport number, an identity number, and biometric information.

4. The transaction arrangement of claim 1, wherein the identification service computing system is part of a system of an authority selected from a non-exhaustive group consisting of a vehicle licensing authority, a passport control authority, a financial institution, a tax authority, and a government records authority.

5. The transaction arrangement of claim 1, wherein the borrower identification details include consent from such borrower in compliance with privacy and/or security requirements.

6. The transaction arrangement of claim 1, wherein the property registry computing system includes records selected from a non-exhaustive group consisting of an immovable property street address, a lot or plan number, a standard parcel identifier, and a movable property identification or registration number.

7. The transaction arrangement of claim 1, wherein the mortgage brokering computing system recording a transaction in a blockchain comprises said system being configured to use an alternative chain based on the block chain algorithm to achieve distributed consensus of said transactions.

8. The transaction arrangement of claim 1, wherein the lender discrimination model comprises a plurality of lending requirements against which a borrower's suitability for a mortgage is assessed.

9. The transaction arrangement of claim 1, wherein the mortgage brokering computing system is configured to compile the lender discrimination model from captured lending requirements to produce at least two categories of lending decisions.

10. The transaction arrangement of claim 9, wherein the mortgage brokering computing system automatically comparing the borrower identification details, creditworthiness rating, asset identification details and asset valuation with the discrimination model to produce a lending decision comprises said system categorising these details into the at least two categories of lending decisions.

11. The transaction arrangement of claim 9, wherein each category of lending decisions indicates a particular mortgage product of the lender.

12. The transaction arrangement of claim 1, wherein the mortgage brokering computing system is adapted to automatically generate and/or populate supporting documentation with transaction data.

13. The transaction arrangement of claim 12, wherein the mortgage brokering computing system is adapted to provide such populated supporting documentation to a party for electronic signature, and to record such transaction in a blockchain.

14. The transaction arrangement of claim 1, wherein, where the lending decision is in the affirmative, the mortgage brokering computing system is further configured to facilitate a transfer of funds from the lender to secure the asset for the borrower.

15. A mortgage brokering computing system comprising:
(1) an input interface configured to receive transaction data from a communications network;
(2) an output interface configured to transmit transaction data onto a communications network;
(3) a non-transitory electronic storage device configured to house a database for storing processor instructions; and
(4) a processor operatively arranged in signal communication with the input and output interfaces and the storage device, said processor adapted to:
for a borrower:
i) capture borrower identification details;
ii) verify such captured identification details with a third-party identification service;
iii) establish a creditworthiness rating with a third-party financial institution; and
iv) record the capturing, verification and creditworthiness transactions in a blockchain;
for an asset to be mortgaged:
i) capture asset identification details;
ii) verify such captured asset details with a third-party property registry;
iii) value the verified asset; and
iv) record the capturing, verification and valuation transactions in a blockchain;
for a lender:
i) configure a discrimination model based on lending requirements;
ii) automatically compare the borrower identification details, creditworthiness rating, asset identification details and asset valuation with the discrimination model to produce a lending decision; and
iii) record the comparison transaction and lending decision in a blockchain;
wherein the system operatively generates aggregate blockchains providing a demonstrable and auditable history for the respective identification details and subsequent transactions for brokering a mortgage.

16. The mortgage brokering computing system of claim 15, wherein the processor is further configured to:
i) transact with a financial institution via the communications network to review a creditworthiness rating of a borrower having a mortgage with a lender;
ii) record the creditworthiness review transaction in a blockchain via the communications network;
iii) compare the creditworthiness review with a lender's discrimination model based on lending requirements; and
iv) if the borrower's creditworthiness rating compares unfavourably with the lender's discrimination model, automatically notify the lender;
wherein the system operatively creates an auditable history of the creditworthiness review transaction to facilitate automatic and periodic monitoring of the lender's borrowers to notify said lender should a borrower's creditworthiness rating change with respect to such lender's discrimination model.

17. A computer-implemented mortgage brokering method comprising the steps of:
for a borrower:
i) capturing borrower identification details;
ii) verifying such captured identification details with a third-party identification service;
iii) establishing a creditworthiness rating with a third-party financial institution; and
iv) recording the capturing, verification and creditworthiness transactions in a blockchain;
for an asset to be mortgaged:
i) capturing asset identification details;
ii) verifying such captured asset details with a third-party property registry;
iii) valuing the verified asset; and
iv) recording the capturing, verification and valuation transactions in a blockchain;
for a lender:
i) configuring a discrimination model based on lending requirements;
ii) automatically comparing the borrower identification details, creditworthiness rating, asset identification details and asset valuation with the discrimination model to produce a lending decision; and
iii) recording the comparison transaction and lending decision in a blockchain;
wherein the aggregate blockchains provide a demonstrable and auditable history for the respective identification details and subsequent transactions for brokering a mortgage.

18. The method of claim 17, which comprises the further steps of:
i) transacting with the financial institution to review a creditworthiness rating of a borrower having a mortgage with a lender;
ii) recording the creditworthiness review transaction in a blockchain;
iii) comparing the creditworthiness review with a lender's discrimination model based on lending requirements; and
iv) if the borrower's creditworthiness rating compares unfavourably with the lender's discrimination model, automatically notifying the lender;
wherein an auditable history of the creditworthiness review transaction is created to facilitate automatic and periodic monitoring of the lender's borrowers to notify said lender should a borrower's creditworthiness rating change with respect to such lender's discrimination model.
